(19) United States
(12) Patent Application Publication
(10) Pub. No.: US 2011/0138340 A1
(43) Pub. Date: Jun. 9, 2011

(54) Rotating Hierarchy Cone User Interface

(75) Inventors: Morten Holm-Petersen, Copenhagen (DK); David Kocmick, Holte (DK)

(73) Assignee: Microsoft Corporation, Redmond, WA (US)

(21) Appl. No.: 12/634,353

(22) Filed: Dec. 9, 2009

(51) Int. Cl. G06F 3/048

(52) U.S. Cl. 715/854

(57) ABSTRACT

A user interface for business applications provides users a navigable top-down view of a hierarchical structure through a rotating hierarchy cone. The cone presents a partial view of a circularly organized hierarchy of parent and child nodes enabling users to view detail information, select tasks to be performed, and modify the structure while having an overall picture of the hierarchy. Users are enabled to rotate the cone to view an unlimited number of segments of the circularly organized hierarchy and to navigate across multiple levels up or down focusing on branches of the structure.

### BACKGROUND

Business solution applications provide a large number of powerful tools addressing many aspects of businesses and other organizations. A majority of such applications provide integrated capabilities for financial management, distribution, manufacturing, project accounting, human resource management, field service management, business analytics, and comparable areas. An important aspect of these applications is providing automated business accounting functions.

Users of business software frequently need to browse large hierarchical structures of for example organizational units, account structures, employee-reporting structures, and comparable ones. Such hierarchies may have large numbers of nodes. Nodes in the tens of thousands are not uncommon. In addition, a single node in such a hierarchy may have several hundred children rendering the tree very wide.

In presenting such large structures to users with sufficient detail, conventional user interfaces fail to satisfy the needs of the users. Traditional collapsible tree structures or matrix style presentations are limited in how much information they can provide in the viewport. Furthermore, when users zoom onto a particular area of the structure, they lose the “bigger picture” of the overall hierarchy. Hyperbolic tree-style views can handle relatively large hierarchies and may offer in-line preview of the next branch levels. However, a hyperbolic tree cannot scale to a large number of children of a single parent node since the view is limited by the number of nodes that can be fitted on an in-view circle. In addition, hyperbolic trees lay out nodes three hundred sixty degrees around the current focus node, which may confuse many users who expect child nodes to be shown below their parent.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a user interface for business applications providing users a navigable top-down view of a hierarchical structure through a rotating hierarchy cone. The cone presents a partial view of a circularly organized hierarchy of parent and child nodes enabling users to view detail information, select tasks to be performed, and modify the structure while having an overall picture of the hierarchy. According to some embodiments, users are enabled to rotate the cone to view different segments of the circularly organized hierarchy and to navigate across multiple levels through branches of the structure.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating major elements associated with a business application employing a rotating hierarchical cone user interface according to embodiments;

FIG. 2 illustrates a user interface according to embodiments along with example controls and information view panes;

FIG. 3 illustrates example elements of a rotating hierarchy cone that may be used in a business application user interface such as the user interface of FIG. 2;

FIG. 4 illustrates additional example elements and how the hierarchical structure may be modified in the example user interface of FIG. 2;

FIG. 5 illustrates a partial view of a rotating cone where an action menu for related tasks and an information view pane with detail information about a selected element may be provided according to some embodiments;

FIG. 6 is a networked environment, where a system according to embodiments may be implemented;

FIG. 7 is a block diagram of an example computing operating environment, where a user interface according to embodiments may be provided; and

FIG. 8 illustrates a logic flow diagram for a process of providing a user interface employing a rotating hierarchy cone according to embodiments.

### DETAILED DESCRIPTION

As briefly described above, users may be provided a navigable top-down view of a hierarchical structure through a rotating hierarchy cone. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media. The computer program product may also be a propagated signal on a carrier (e.g. a frequency or phase modulated signal) or medium readable by a computing system and encoding a computer program of instructions for executing a computer process.

Throughout this specification, the term “platform” may be a combination of software and hardware components for providing various computing services such as business applications. Examples of platforms include, but are not limited to, a hosted service executed over a plurality of servers, an application executed on a single server, and comparable systems. The term “server” refers to a computing device executing one or more software programs typically in a networked environment. The term “client” refers to a computing device or software application that provides a user access to data and other software applications through a network connection with other clients and/or servers. More detail on these technologies and example operations is provided below.

The term “rotation” as used herein refers to circular movement of the rotating hierarchy cone structure in response to a user input such as a mouse click, a keyboard entry, a gesture, or even a voice-based command. Such a movement brings into view a different segment of the circularly organized hierarchy structure in a user selected direction. The term “navigation” refers to a change in the presented rotating hierarchy cone along the direction of its levels (away from the center node). Thus, various levels of child nodes may be brought into view by navigating down a branch in response to a user input such as a mouse click, a keyboard entry, a gesture, or a voice-based command. Various methods of performing rotation and navigation are described in more detail below

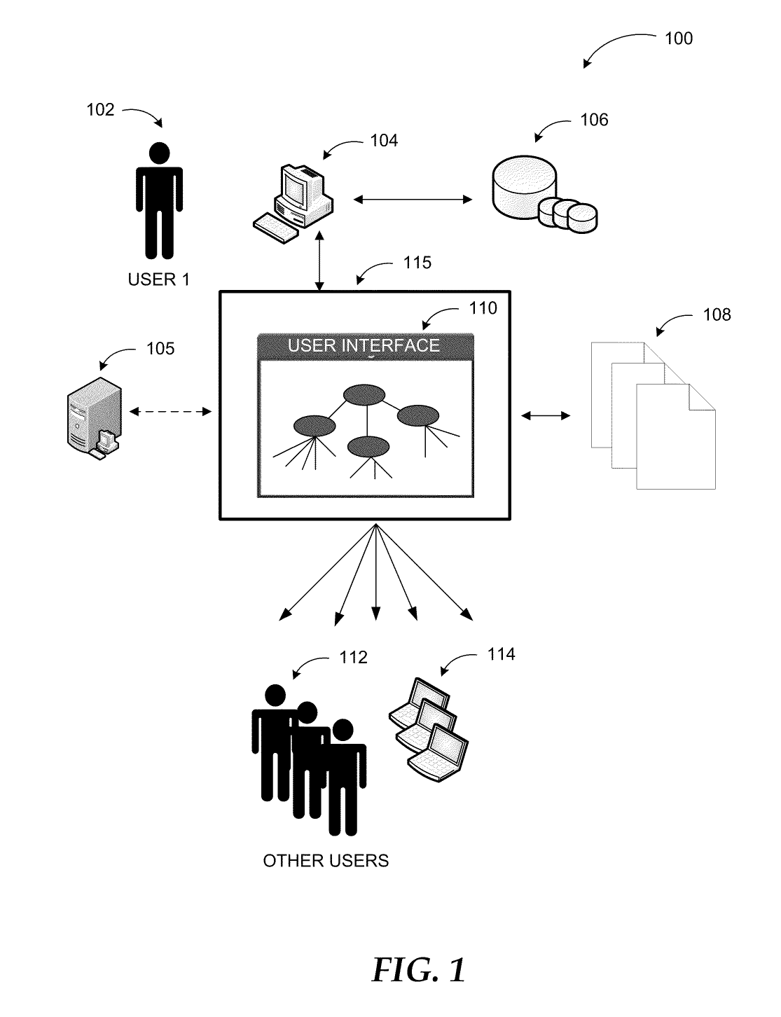

FIG. 1 includes conceptual diagram 100 illustrating major elements associated with business application that may employ a rotating hierarchy cone user interface according to embodiments. At the core of the elements shown in diagram 100 is business application 115 that may be implemented in the specific context of organizational operations such as management structure, customer relations, geographic associations, etc. Business application 115 may be a stand-alone financial record keeping (or accounting) system, or it can be a financial module of a larger system, such as an enterprise resource planning (ERP) system. Business application, as used herein, is not limited to accounting systems. Hierarchy views may also be used in systems focusing on operational aspects such as manufacturing, warehouse management, and comparable ones. Thus, business application 115 refers to systems involving various aspects of organizations. As such, business application 115 may be executed by standalone computer 104 or by server 105 and accessed by computer 104.

Business application 115 may include or interact with a number of components such as inventory systems and similar ones. Business application 115 may support user-definable transaction dimensions for tracking and business analytics. A user-definable transaction dimension is similar to a variable that contains additional information relative to a transaction. These user-definable transaction dimensions are used to classify, report, and analyze financial transactions based upon a user's specific business needs. A number of transaction dimensions that can be defined by a user may be unlimited and include such dimensions as cost center, profit center, region, hours, and comparable ones, as well as predefined system transaction dimensions such as customer, vendor, item, site, and similar ones.

Business application 115 may also provide a relational chart of accounts or other organizational aspects (e.g. organizational diagrams, manager-employee reporting relationships, geographical location groupings, and comparable ones) through user interface (UI) 110 that includes a hierarchical presentation of the selected information. The relational chart may provide one or more dimensions associated with the selected business aspect(s). Some information may be listed in multiple instances with different dimension combinations.

In a system according to embodiments, a user (e.g. user 102) may be enabled to add, remove, or otherwise edit settings within the business application 115 by editing the relational chart through the UI 110 as discussed in more detail below. In configuring elements of the system such as organizational hierarchies or other hierarchical data, user 102 may utilize data stored in external data stores such as data stores 106. Business application 115 may generate reports and other analysis tools and results (e.g. documents 108) based on the configured system structure automatically or upon request. The data configured by user 102 may become published and available to other users 112 accessing the system through computing devices 114. Other users 112 may also be enabled to configure/modify elements of the system and combinations through UI 110.

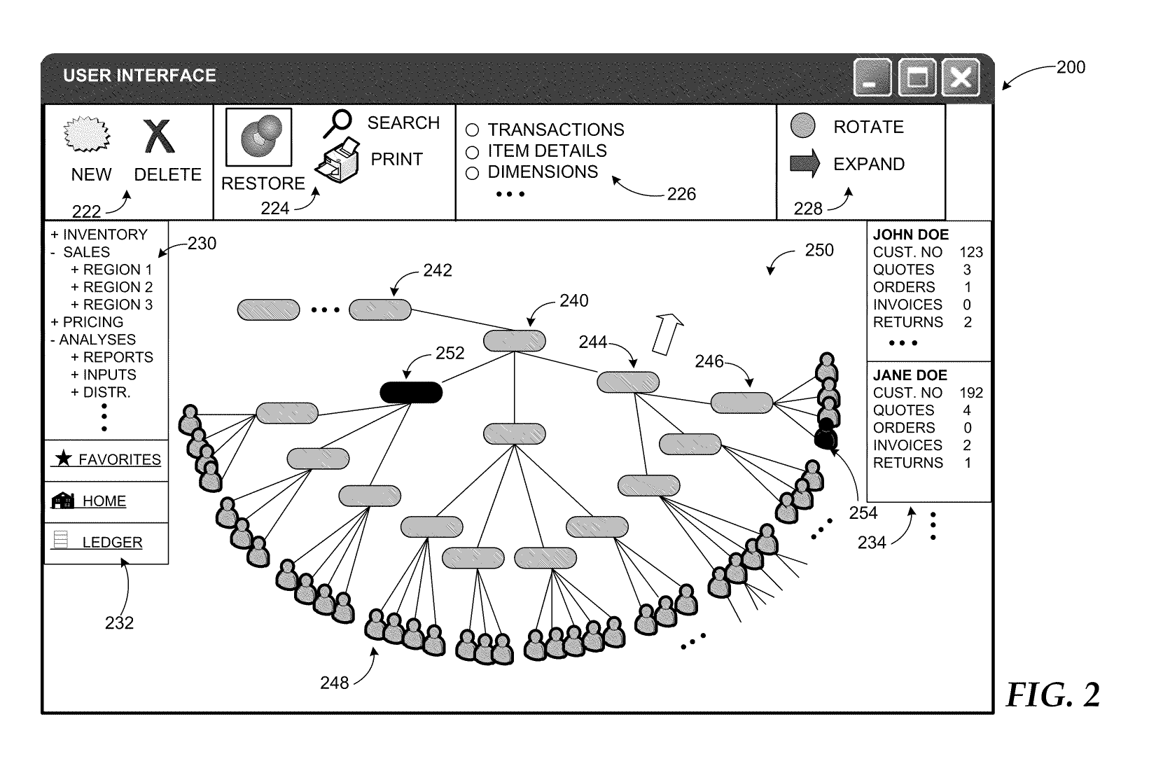

FIG. 2 illustrates user interface 200 according to embodiments along with example controls and information view panes. As mentioned previously, viewing and browsing of hierarchical data is a challenging prospect. Users typically desire to move quickly through deep hierarchies. Traditional collapsible tree style presentations require too many clicks to get to a relevant leaf node because every level has to be expanded by the user. Organizational chart-style canvasses have to be scrolled and users may lose the “big picture” while focusing in a particular area of interest. A rotating cone hierarchy presentation according to embodiments enables users to “see ahead” so they do not need to manually visit every corner of the structure to learn that there is nothing of relevance there. Furthermore, users have the greater hierarchical structure visible while they are focused on a deeper level node or nodes and they can easily move to an unpresented section of the structure from a current view.

A UI according to embodiments reduces the complexity of large hierarchical structures and allows users to define new elements, modify elements their places within the structure, and view information associated with elements (e.g. analysis reports, etc.) in a single view. In addition to the hierarchy presentation through rotating cone 250, user interface (UI) 200 also presents a number of controls for performing actions associated with the relational structure and its elements. Example controls may include icons for opening new presentations or deleting a presentation or its elements (222), icons for restoring a saved presentation, searching through a structure, or printing a present view of a structure (224), textual elements for viewing transactions, item details, dimensions, and the like (226), and icons/textual elements for moving around the presented structure such as rotating or expanding (228).

UI 200 may also include view ports for detail information about select elements such as view port 234 and a different style presentation of at least a portion of the structure (e.g. collapsible tree style presentation in view port 230). Other elements of the UI 200 may include links to favorites, a home page, or select applications/views such as a ledger (viewport 232). UI 200 is only an example presentation of what a user interface according to embodiments may look like, and does not constitute a limitation on embodiments. A user interface employing a rotating cone hierarchy presentation may be presented with additional or fewer elements/controls using various combinations of graphic and textual elements, color schemes, styles, and the like.

At the heart of UI 200 is the rotating cone 250 where the hierarchical structure is presented with a center node 240 at the center and lower level nodes (244, 246, 248, etc.) positioned circularly around the center node 240, which may or may not be the top level node of the hierarchy. Hierarchical parent-child relationships are reflected as connections between the nodes. Since the rotating cone 250 only presents a portion of the entire structure, unpresented elements may be reflected in a “collapsed” format such as an address bar. When a user focuses on a particular node by clicking on it, hovering over it, or indicating the focus by other means (e.g. keyboard or voice-based input), that node may be highlighted or indicated in a comparable way (e.g. nodes 252, 254) and information associated with the selected node(s) may be presented in various ways (e.g. in viewport 234).

Rotating cone 250 provides a top-down view onto portion of a circle. As mentioned above, the hierarchy is laid out with the top node at the top of a cone and branches unfolding multiple levels down one side. The size of the presented portion of the circle may be determined automatically based on screen resolution, available information, etc. or based on user selection. For example, the rotating cone may cover one third of a circle. Other sizes based on angle (e.g. 140 deg., 106 deg. etc.) may also be used. If the hierarchy is very wide, users may rotate the cone to bring side branches into view. Users are further enabled to navigate down deep branches by selecting a node towards the bottom of the cone, which brings this node to the top of the cone and unfolds the branches under this node.

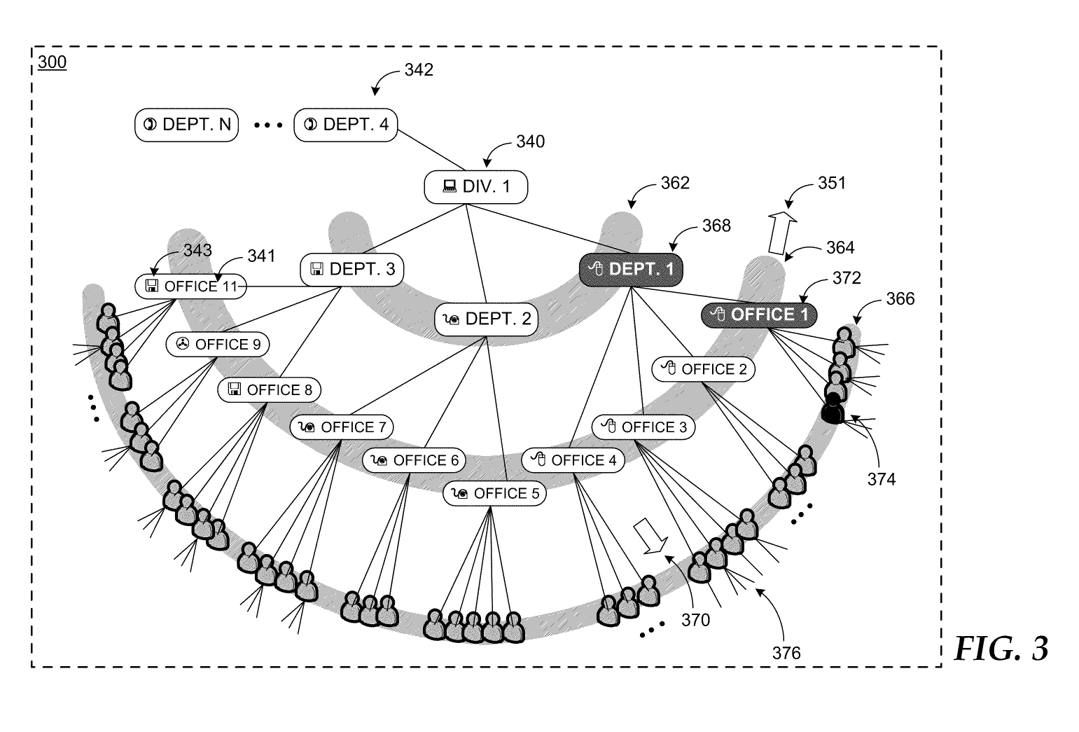

FIG. 3 illustrates example elements of a rotating hierarchy cone 300 that may be used in a business application user interface such as the user interface of FIG. 2. As discussed above, the hierarchy is displayed on the outside surface of a cone and the user looks vertically down at the cone through a viewport, which reveals a pie segment. For example, the user interface may display about 160 degrees out of the full 360 degrees of a cone, which may include an arbitrary number of elements. Thus, the number of branches displayed is not proportional to the unpresented branches of the hierarchy. The center of the cone is at the top of the user's viewport. The rim of the visible segment of the cone is visible along the bottom and lower sides of the viewport. The hierarchy is laid out based on a center node (e.g. center node 240), which is shown at the top of the cone. In the viewport, this becomes the top-center position. Children and branches of the center node are laid out from the top towards the bottom of the cone. All children at the same level may be laid out with an equal distance from the top, which forms semi-circles (362, 364, and 366) down the cone of children at the same level. Embodiments are not limited to equidistant circles for representing different levels, however. Other graphical approaches such as elliptical or similar presentation of the hierarchy levels may also be used.

When the rotating cone 300 is viewed top-down through the viewport, the branches fan out downwards from the top and the children appear to sit on 160-degree semi-circles that spread out from the top and center of the view. The semi-circles (362, 364, and 366) can fit a longer line inside the viewport than straight horizontal lines across the viewport could. That provides room for more nodes in view. In addition to this, nodes (e.g. 349, 368, and 372) are typically shaped to be wider than they are tall (in the example illustration four times wider than tall). This means that towards the sides where the ends of the semi-circle points upwards, nodes can be stacked more densely on top of each other than they can in the middle of the view. Together the longer line and closer node stacking can fit more nodes in the same view.

The center node is the top of the visible hierarchy but not necessarily the top of the entire hierarchy. If a user selects a node further down the cone (e.g. node 368) this node may be moved to the top and branches under that node shown on the cone. Parent nodes for the current center node may be moved to a horizontal “address bar” 342 at the top left corner of the visualization. The parent nodes shown in the address bar may be linked together and the last element linked to the center node to indicate that the hierarchy continues upwards into the address bar 342. If the address bar 342 fills up, then nodes in the middle of the address sequence may be hidden and an ellipsis ( . . . ) may be shown to indicate that one or more nodes are hidden.

The presentation of the nodes may provide summary information to the user such as name of the node and graphic information about the type of the node. For example, the textual information in node 341 indicates the node represents Office 11 of an organization under Department 3. The icon 343 in the same node representation indicates the node is associated with data storage (e.g. data storage division of a computer technology company). Of course, additional information may be displayed using various schemes. Moreover, further information may be presented in form of a new viewport, a pop-up menu, or comparable forms upon detecting the user's focus on a particular node.

When the user focuses on a node (e.g. node 368, 372, or 374), that node may be highlighted and further actions associated with the selected node enabled (e.g. display of detail information, enabling user to modify information or position of the node, etc.). As mentioned before, the hierarchy between parent and child nodes may be displayed as connections. If the lowest level of displayed nodes is not the lowest level of the hierarchy, open ended connections 376 may be used to indicate the existence of further levels below the displayed ones.

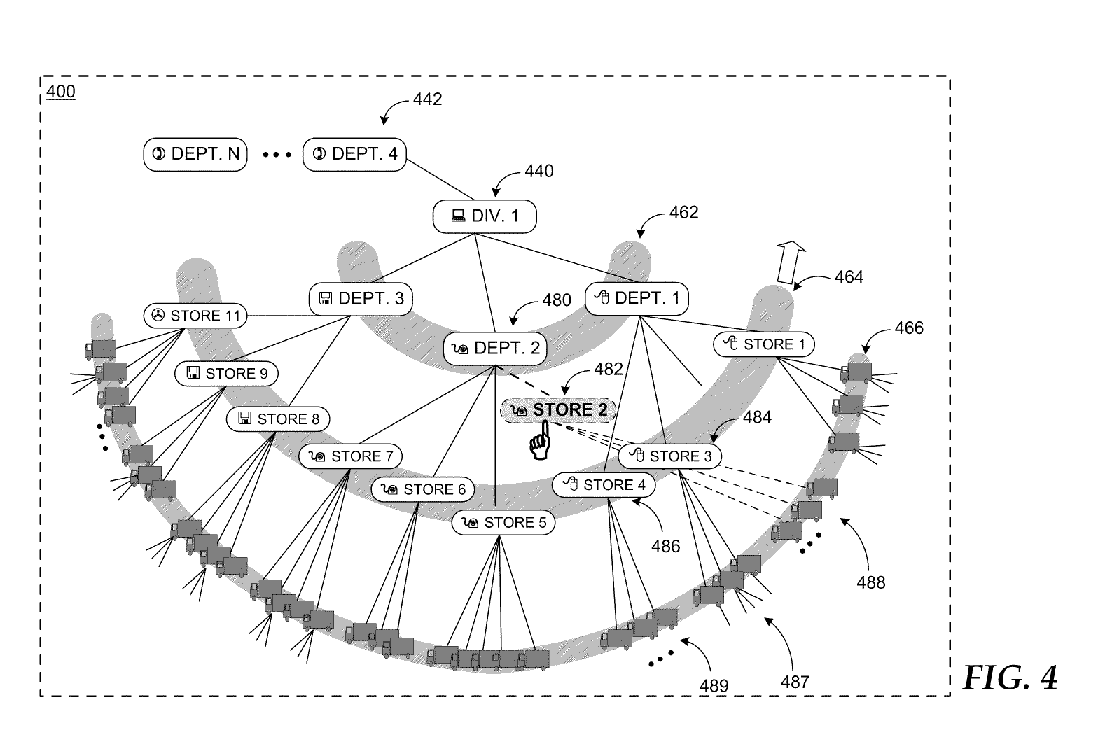

The top-down view onto the rotating cone 300 is used to create a fish-eye effect by which the center node 340 is shown at a large size referred to herein as 100%. Nodes in the address bar 342 may be shown at a smaller percentage of the center node 340 (e.g. 80%). The size of the nodes on lower levels may be progressively smaller compared to the center node 340. Other sizing schemes may also be applied. Furthermore, automatic or user-defined limits may be placed on the size of nodes at each level. At some (or all) levels, the nodes may also be displayed as icons. For example, the example structure in rotating cone 300 shows a computer technology company's different departments and offices based on various technology segments (data storage, input devices, webcams, etc.) with the semi circle 366 representing lowest displayed level representing sales people. The nodes at this level are displayed as icons. In other examples, other icons may be used to represent the nodes (e.g. the truck icon representing delivery trucks in FIG. 4).

The overall hierarchical structure may include more branches and levels than what is displayed by the rotating cone 300. If there are more branches than shown, the user may rotate the cone by clicking on a rotation button 351, dragging the canvas with a pointing device (e.g. a mouse), making a gesture across a touch-sensitive display, entering a keyboard command, or speaking a voice based command. The rotation may be animated and the amount of rotation may be automatic or user defined. Rotating cone 300 does not display a segment of the entire hierarchy circle in a 1-to-1 proportion. Thus, the hierarchy may include an arbitrary number of branches, a portion of which is displayed by the cone at any given time. The rotation may be in either direction depending on user selection.

According to some embodiments, the following algorithm may be used to perform rotation: if there are more nodes than can fit in view in any of the visible rings, lay out enough additional branches outside the view to fill one rotation (and in both directions if two rotation buttons are shown); lay out the additional branches along the same semi-circles as they bend out of view and over the top; rotate the nodes in these branches to the angle that makes them horizontal when this slice is rotated into view; and set these additional branches to invisible.

The rotation may be animated by: setting the additional out-of-view branches to visible (in the desired direction of rotation if both are enabled); rotating the canvas with the branches around the center node; if the user rotated by dragging the mouse (and thus may not have rotated a full pie slice) then adjusting the angle of all nodes in view to horizontal; setting branches that should be out-of-view to invisible; laying out additional branches outside of view to enable the next rotation; and in the opposite direction, removing any branches beyond one slice out of view.

The above algorithms ensure that the next pie slice of branches is loaded and prepared if users choose to rotate the view. Out-of-view slices are not all generated at the same time, which could cause them to wrap over the top and back into view at the other side. Instead, they are added and removed one by one. This means the rotation can continue in the same direction to load infinite amounts of sibling branches while keeping the same parent node at the top of the view. The animation of the rotation enables the users to understand that sibling branches are coming in from the side. If the display switched instantly to show the new branches, users may not be able to understand what they are looking at.

Another movement across the structure is navigation across levels. By clicking on a navigation button 370, making a gesture across a touch-sensitive display, entering a keyboard command, or speaking a voice based command, the user may be enabled to bring into view invisible lower levels of the hierarchy (moving upper levels into the address bar 342) of vice versa. Navigation may also be initiated in response to the user selecting a node in the lowest displayed level. Furthermore, navigation may be animated or instantaneous.

FIG. 4 illustrates additional example elements and how the hierarchical structure may be modified in the example user interface of FIG. 2. In the example rotating cone 400 of FIG. 4, the center node 440 represents Division 1 of a company with departments 1, 2, and 3 at the lower level 462 and stores 1 through 11 at the next lower level 464. At the lowest displayed level 466 are delivery truck nodes (e.g. 488, 489) reporting to various stores of the level 464 with further lower levels being indicated by open ended connections 487.

Users are enabled to edit the hierarchical structure, in a system according to embodiments, directly in the rotating cone by using cut and paste operations or by dragging nodes (e.g. with a mouse or using gestures). Beyond adding and removing nodes, users can re-sequence the children under a parent and move nodes/branches to other parents.

According to an example scenario, a user selects store 2 (482) and drags it from parent node Department 1 toward parent node Department 2. Detecting this desired change in the hierarchy, the user interface provides feedback using a highlighting scheme for the affected node and its children as well as making the connections between the affected nodes a different style (dashed lines). If the feedback matches the user's intent, the system may rearrange the nodes in levels 464 and 466 and connect Store 2 (482) to its new parent node 480. Other nodes at the same level (e.g. nodes 484, 486) may be moved to accommodate the new child node. Similarly, lowest level nodes (delivery truck nodes 488) may be moved along with their parent node as well.

If the modification involves navigation to a lower level, center node 440 may be moved to the address bar 442 and a new center node moved up from level 462. Rearrangement of nodes is not limited to moves within the same level. A node may be moved up or down to other levels, nodes from one level may be reconnected to a node in another level as their new parent, and the like. Rules for rearranging nodes may be defined by the system or by users. For example, limitations such as not allowing a node to be moved to report to one of its children or not allowing cross-moves between certain branches may be predefined and enforced.

A system according to embodiments may implement following algorithm to enable hierarchical structure modifications: to initiate a drag, make the immediate parent of the dragged node the focus node (e.g. highlight) and show a highlighted line from the dragged node to the focus node to indicate the current relationship. If the center node is being dragged, the system may assume this is an attempt to move the node to another parent and allow drop on a parent node in the address bar and not the lowest parent.

If a node below the center node is being dragged, the mouse cursor's position at any time may be used to determine if this is an attempt to re-sequence siblings or to move the dragged node to a different parent. If the mouse cursor is closer to the focus node (the parent of the dragged node) or any of its children than it is to other nodes, then the action may be assumed as an attempt to re-sequence siblings (which will stay under the same parent). The existing parent of the dragged node may be maintained as the focus node and a highlighted line from the focus node to the dragged node continuously updated. As users move the node over or between other siblings, a determination may be made if the mouse cursor is to the left or right of the center of the nearest sibling. Then, a dotted line may be displayed (as an insert cursor) next to the sibling on the side the mouse cursor is the closest to. The dotted line may be made appear as a short line segment (the height of the sibling) out of a line that extends from the parent (same angle as a node connector line would have to that position). The visible piece may be centered vertically between the two siblings it sits between (or right next to the sibling if it is the outer sibling). If user lets go of the mouse button in this state, the dragged node may be inserted into the sibling sequence there. Then, the entire hierarchy may be laid out again to best fit the varying branches of the re-sequenced nodes.

If the mouse cursor is closer to nodes that are not the focus node or any of its siblings, then the system may assume this is an attempt to move the dragged node to a new parent and determine the parent of the node closest to the mouse cursor. If the parent of the hovered node is a child of the dragged node, the mouse cursor icon may be changed to the “not allowed” circle with a line through it and the parent of the dragged node maintained as the focus node. On the other hand, if the parent of the hovered node is not a child of the dragged node then the system may indicate that this can become the new parent of the dragged node, make the parent of the hovered node the focus node and show a highlighted line from the focus node to the dragged node. If user lets go of the mouse button in this state, the dragged node (and its branch) may be moved under the focus node and the entire hierarchy laid out again.

As mentioned previously, various input mechanisms may be used to enable users to interact with the user interface displaying the rotating cone. For example, keyboard commands may be used to perform actions associated with modifying the viewed segment of elements of the cone. Example keyboard commands may include “ArrowUp” to set focus to the parent of the current node, “ArrowDown” to set focus to the child node that is the closest to being positioned vertically under the current node; “ArrowLeft” to set focus to the sibling node to the left of the current node. If the current node is the left-most child, then set focus to the nearest “cousin” node to the left (under another parent); “ArrowRight” to set focus to the sibling node to the right of the current node (if the current node is the right-most child, then set focus to the nearest “cousin” node to the right under another parent); “SpaceBar” to make a focus node the center node (re-layout the hierarchy); and similar ones.

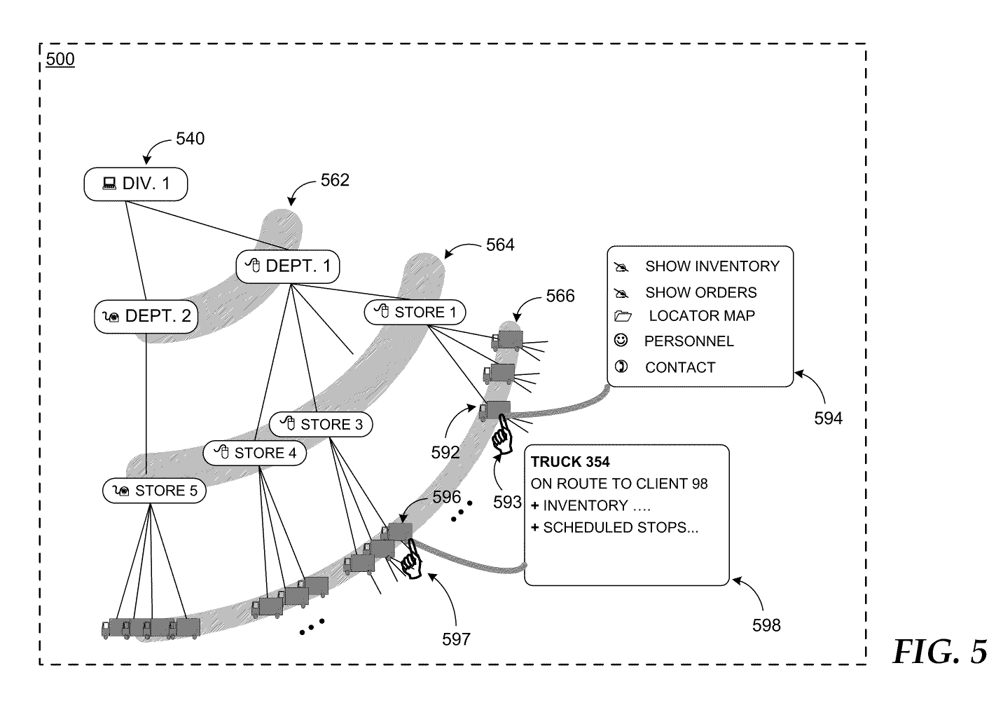

FIG. 5 illustrates a partial view of a rotating cone 500 where an action menu for related tasks and an information view pane with detail information about a selected element may be provided according to some embodiments. For illustration purposes, only a portion of a rotating cone 500 is shown in FIG. 5. As in FIG. 4, the center node 540 represents Division 1 of a company with departments 1 and 2 at the lower level 562 and stores 1, 2, 3, 4, and 5 at the next lower level 564. At the lowest displayed level 566 are delivery trucks nodes (e.g. 592, 596) reporting to various stores of the level 564.

According to an example scenario, one of the delivery truck nodes (592) is selected by a user (593) and a pop-up menu 594 of related actions is displayed near the selected element. The example actions include “show inventory”, “show orders”, “locator map”, “personnel”, or “contact”. Thus, actions related to the business application or other applications may be presented to the user. The actions may be provided using a graphical or textual scheme, or a combination of both.

According to another example scenario, node 596 representing another delivery truck may be selected by the user (597) and viewport 598 providing detail information about the selected node may be displayed. In the example viewport 598, the truck's number, its current status, its inventory, and scheduled stops are presented. Of course, other information (graphic or textual) may also be presented.

The actions or the detail information discussed here may be provided in various presentation forms such as a pop-up menu, a viewport inside or outside the user interface, and similar ones. The size and location of viewports may be automatically adjusted such that they do not interfere with the visualization by blocking neighboring nodes, for example.

A number of textual and graphical schemes may be utilized in a UI according to embodiments to enhance user experience. For example, individual nodes, branches, or levels may be distinguished through a coloring scheme or an alternating shading scheme. Highlighting, different font schemes, outlining schemes may be employed to indicate the user's current focus or other distinguishing aspects. Other schemes may also be implemented.

Individual nodes and node combinations may also be modified, created, deleted using standard functions such as copy, paste, delete, or move. Thus, a UI according to embodiments enables the user to set up and modify hierarchical structures in a graphical manner. The user is offered one place to not only view an entire hierarchical structure but also insight to how the nodes are set up and ultimately behave.

While embodiments have been discussed above using a general framework and specific examples, they are intended to provide a general guideline to be used for describing a user interface for presenting large hierarchical structures. Other embodiments may be implemented with different textual and graphical elements, combinations, and configurations using the principles described herein. Thus, embodiments are not limited to the example systems, components, elements, graphical aspects, and configurations discussed in FIG. 2 through FIG. 5, and can be implemented with other elements and configurations.

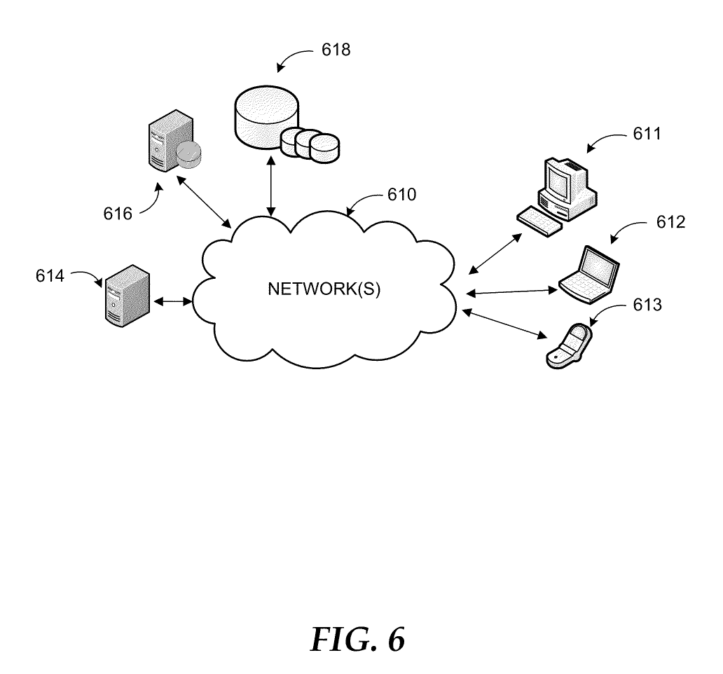

FIG. 6 is an example networked environment, where embodiments may be implemented. A platform providing a user interface employing a rotating hierarchy cone may be implemented via software executed over one or more servers (e.g. server 614) such as a hosted service. The platform may communicate with applications on individual computing devices such as a desktop computer 611, laptop computer 612, and smart phone 613 (‘client devices’) through network(s) 610.

Client devices 611-613 are capable of communicating through a variety of modes and exchange documents. A business application executed in one of the client devices or one of the servers (e.g. server 614) may store and retrieve data associated with the user requested tasks through the user interface to and from a number of sources such as data stores 618, which may be managed by any one of the servers or by database server 616.

Network(s) 610 may comprise any topology of servers, clients, Internet service providers, and communication media. A system according to embodiments may have a static or dynamic topology. Network(s) 610 may include a secure network such as an enterprise network, an unsecure network such as a wireless open network, or the Internet. Network(s) 610 may also comprise a plurality of distinct networks. Network(s) 610 provides communication between the nodes described herein. By way of example, and not limitation, network(s) 610 may include wireless media such as acoustic, RF, infrared and other wireless media.

Many other configurations of computing devices, applications, data sources, and data distribution systems may be employed to implement a system providing a hierarchical structure user interface. Furthermore, the networked environments discussed in FIG. 6 are for illustration purposes only. Embodiments are not limited to the example applications, modules, or processes.

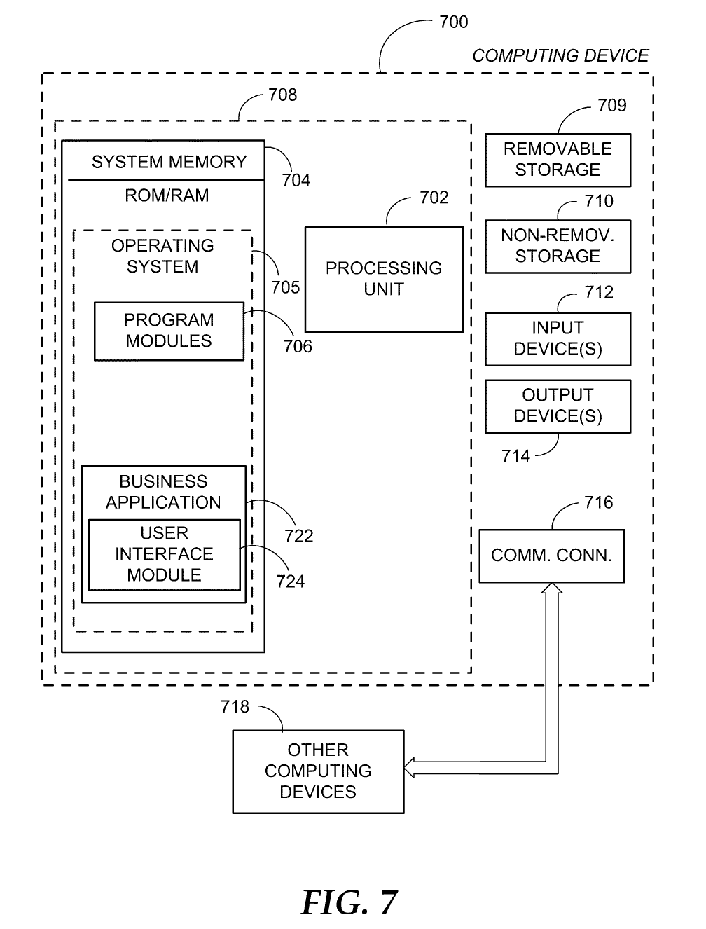

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computer 700. In a basic configuration, computer 700 may include at least one processing unit 702 and system memory 704. Computer 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS® operating systems from MICROSOFT CORPORATION of Redmond, Wash. The system memory 704 may also include one or more software applications such as program modules 706, business application 722, and user interface module 724.

Business application 722 may be an application or an integral part of a hosted service. Business application 722 performs operations associated with classification, reporting, analysis of financial transactions, and similar tasks. User interface module 724 may be a separate application or an integral module of business application 722. User interface module 724 may, among other things, provide a user interface employing a rotating hierarchy cone as discussed in more detail above. This basic configuration is illustrated in FIG. 7 by those components within dashed line 708.

Computer 700 may have additional features or functionality. For example, the computer 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computer 700. Any such computer readable storage media may be part of computer 700. Computer 700 may also have input device(s) 712 such as keyboard, mouse, pen, voice input device, touch input device, and comparable input devices. Output device(s) 714 such as a display, speakers, printer, and other types of output devices may also be included. An interactive display may act both as an input device and output device. These devices are well known in the art and need not be discussed at length here.

Computer 700 may also contain communication connections 716 that allow the device to communicate with other devices 718, such as over a wireless network in a distributed computing environment, a satellite link, a cellular link, and comparable mechanisms. Other devices 718 may include computer device(s) that execute other applications. Communication connection(s) 716 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

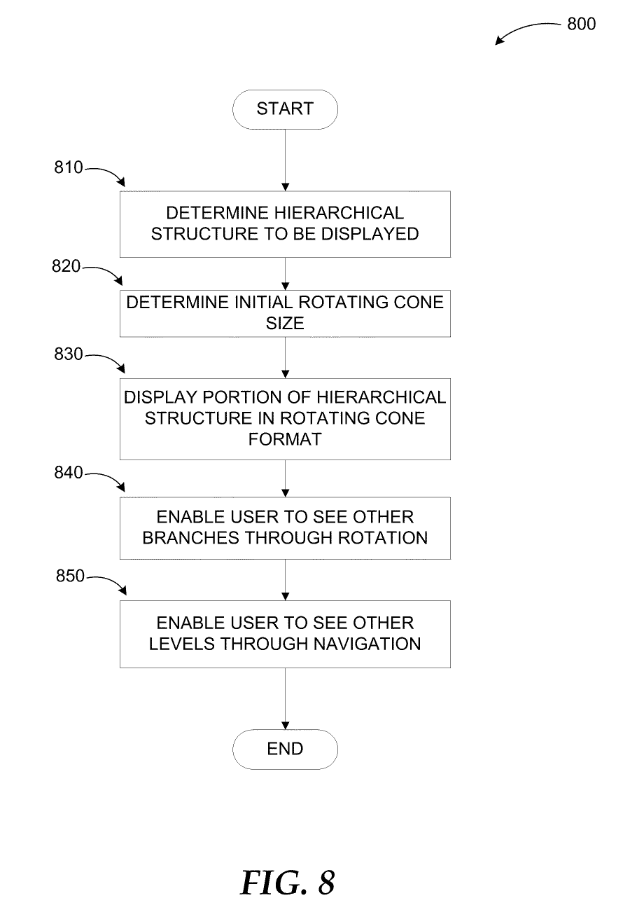

FIG. 8 illustrates a logic flow diagram for a process 800 of providing a user interface employing a rotating hierarchy cone according to embodiments. Process 800 may be implemented by any business application.

In a user interface according to embodiments, the hierarchy is laid out on a cone, which is viewed top-down and moved up in the viewport so its center is shown at the top of the viewport. This means that the center node is perceived as the top node and all nodes towards the bottom of the cone are perceived as children of the center node. That maintains the top-down orientation that users expect in a hierarchy while still bending lines for each level in the hierarchy into rings, which can fit more nodes in the view than flat horizontal lines can. Users are provided multiple levels of child nodes laid out on the cone and can directly select a node multiple levels down to bring it to the center. By moving the in-between node levels to an “address bar” area in the visualization, a sequence of parents is maintained in view such that the users have a full description of the path to the current focus. Moreover, the rotating hierarchy cone can handle an arbitrary number of children under one parent. By laying out nodes in a segment of the hierarchy structure under the center node, a user interface according to embodiments allows users to rotate in an endless number of additional “slices” to allow for an infinite number of nodes.

Process 800 begins with operation 810, where the hierarchical structure to be displayed is determined The structure may be obtained from a business application, a database, or other sources. Next, the initial rotating cone size is determined at operation 820. The rotating cone size may depend on screen resolution, available viewport size, user preferences, and comparable parameters.

Following operation 820, a selected portion of the hierarchical structure is displayed at operation 830 in rotating cone format as discussed herein. The displayed portion may be selected based on user input or a set of default parameters. Along with the rotating cone information associated with elements of the structure, controls to perform actions such as moving elements, adding new elements, analyzing the structure, and the like, may also be provided in the user interface.

At operation 840, the user may be enabled to see different branches of the structure by rotating the cone as discussed in conjunction with FIG. 3. The user may also be enabled to see other levels of the hierarchical structure by navigating up or down at operation 850.

The operations included in process 800 are for illustration purposes. Providing a user interface with a rotating hierarchy cone may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for providing a user interface to interact with a hierarchical structure, the method comprising:
determining a portion of the hierarchical structure to be displayed;
determining an initial size for a rotating cone presentation to display the portion of the hierarchical structure; and
displaying the portion of the hierarchical structure employing the rotating cone such that a user is enabled to interact with nodes and node combinations of the hierarchical structure through rotation and navigation actions.

2. The method of claim 1, further comprising:
in response to a user input indicating a rotation, rotating the cone such that a different branch of the hierarchical structure is brought into view.

3. The method of claim 2, further comprising:
moving a branch of nodes in response to a rotation bringing into view another branch of nodes.

4. The method of claim 2, further comprising:
in response to another user input indicating a navigation, navigating through the cone such that a different level of the hierarchical structure is brought into view.

5. The method of claim 4, further comprising:
moving a center node to an address bar of higher level nodes in response to a navigation bringing into view a lower level of nodes;
moving a selected node from the address bar to the center node and displaying its child nodes in response to a navigation selecting the node in the address bar.

6. The method of claim 4, wherein the user input and the other user input include one of: a mouse click, a gesture, a keyboard entry, and a voice command.

7. The method of claim 1, wherein the nodes are presented using at least one from a set of: a textual scheme, a graphical scheme, a color scheme, and a shading scheme.

8. The method of claim 1, further comprising:
providing within the user interface a set of controls for actions associated with the displayed portion of the hierarchical structure employing at least one from a set of: a color scheme, a shading scheme, and a textual scheme.

9. The method of claim 1, further comprising:
enabling a user to perform one of: deleting a node, adding a new node, and modifying a node structure within the displayed hierarchical structure.

10. The method of claim 1, further comprising:
employing at least one from a set of: a highlighting scheme, a graphical scheme, and a textual scheme to indicate one of a node and a combination of nodes currently being focused on by user.

11. A computing device for providing a user interface to interact with a hierarchical structure, the computing device comprising:
a display device;
a memory; and
a processor coupled to the memory, the processor executing a business application configured to:
determine a portion of the hierarchical structure to be displayed;
determine an initial size for a rotating cone presentation to display the portion of the hierarchical structure; and
display the portion of the hierarchical structure employing the rotating cone with a highest level node as center node and remaining nodes in lower levels in concentric semi-circles;
rotate the cone in response to a user input such that a different branch of the hierarchical structure is brought into view; and
navigate through the cone in response to another user input such that a different level of the hierarchical structure is brought into view.

12. The computing device of claim 11, wherein the business application is further configured to:
display one of: available actions and detail information associated with at least one selected node in a viewport.

13. The computing device of claim 12, wherein the viewport is displayed such that neighboring nodes of the at least one selected node are not blocked.

14. The computing device of claim 11, wherein the business application is further configured to:
display the nodes of the hierarchical structure employing at least one from a set of: a textual scheme, a graphical scheme, and a color scheme to provide a user visual feedback associated with entities represented by the nodes.

15. The computing device of claim 11, wherein the business application is further configured to:
present controls to enable a user to rotate and to navigate through the displayed hierarchical structure.

16. The computing device of claim 15, wherein the business application is further configured to:
enable the user to modify the hierarchical structure by dragging a node toward another node; and
rearrange the nodes at affected levels to display the modified hierarchical structure.

17. A computer-readable storage medium having instructions stored thereon for providing a user interface to interact with a hierarchical structure in a business application, the instructions comprising:
determining a portion of the hierarchical structure to be displayed;
determining an initial size for a rotating cone presentation to display the portion of the hierarchical structure; and
displaying the portion of the hierarchical structure employing the rotating cone with a highest level node as center node and remaining nodes in lower levels in concentric semi-circles;
rotating the cone around the center node in response to a user input by:
bringing into view a different slice of the circularly laid out hierarchical structure in an animated manner;
if there are more nodes than that can fit into view, laying out additional branches along same semi-circles as the additional branches bend out of view;
rotating nodes in the additional branches to an angle that makes them horizontal when the slice is rotated into view; and
setting the additional branches to invisible.

18. The computer-readable storage medium of claim 17, wherein the instructions further comprise:
navigating the cone in response to a user input by:
bringing into view a different level of the circularly laid out hierarchical structure in an animated manner; and
if there are more levels than that can fit into view, moving the center node into an address bar.

19. The computer-readable storage medium of claim 17, wherein the instructions further comprise:
modifying the displayed portion of the hierarchical structure in response to a dragging action from a user by:
rendering an immediate parent node of a dragged node a current focus node;
displaying a highlighted line from the dragged node to the current focus node to indicate a current relationship; and
in response to one of: an acknowledgment and a lack of objection from the user, establishing a new parent-child relationship by moving connection lines.

20. The computer-readable storage medium of claim 17, wherein an invisible portion of the hierarchical structure includes an arbitrary number of branches.
